(19) United States
(12) Patent Application Publication
(10) Pub. No.: US 2004/0180146 A1
(43) Pub. Date: Sep. 16, 2004

(54) Coating finishing method

(76) Inventors: Keiichiro Saikawa, Hiratsuka-shi (JP); Takashi Kitamura, Hiratsuka-shi (JP); Kenichi Tomita, Hiratsuka-shi (JP); Takeshi Inoue, Hiratsuka-shi (JP); Masami Sugishima, Hiratsuka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/798,449

(22) Filed: Mar. 12, 2004

(30) Foreign Application Priority Data
Mar. 14, 2003 (JP) 2003-69369

(51) Int. Cl. B05D 1/36

(52) U.S. Cl. 427/407.1; 427/409

(57) ABSTRACT

The present invention relates to a coating finishing method comprising coating a water-based under coating material (I) on a surface of a metal substrate or an old coated face of a metal substrate and then coating a water-based coating material (II) comprising a water-based fatty acid-modified acryl resin as a base resin component, wherein the above water-based coating material (II) contains a pigment in a pigment volume concentration falling in a range of 5 to 45%, and the above water-based fatty acid-modified acryl resin has a form of a fine particle having an average particle diameter falling in a range of 50 to 500 nm. According to the method of the present invention, capable of being formed is a finished coating film which has a good finished appearance and which can maintain a fine view of metal surfaces used for structures such as buildings, bridges and plant facilities over a long period of time.

### TECHNICAL FIELD

The present invention relates to a coating finishing method for a metal substrate surface or an old coated face on a metal substrate using a water-based coating material which is suited for maintaining a fine view of structures such as buildings, bridges and plant facilities over a long period of time.

### BACKGROUND ART

In general, solvent base top coating materials such as an alkyd resin base coating material, an acryl alkyd resin base coating material, a silicon alkyd resin base coating material and a phthalic acid resin base enamel coating material are coated on the surfaces of structures such as buildings, bridges, plant facilities and steel towers after coating rust preventive coating materials. Such coating step comprises usually coating once or twice a rust preventive coating material and then coating thereon once or twice a top coating material such as a phthalic acid resin base enamel coating material, and the coating step is desired to be shortened from an economical point of view. Further, in recent years, environmental protective countermeasures such as a rise in working environment and a strengthen in environmental regulation have become social subjects, and therefore a non-environmental pollution type water-based coating system has come to be required more and more strongly.

It is known as a water-based coating system which is coated on a metal face to coat a water-based rust preventive coating material comprising a water-based alkyd resin as a base resin component and then coat thereon a top coating material comprising an acryl resin emulsion as a base resin component.

However, the existing situation is that the top coating material comprising an acryl resin emulsion as a base resin component forms a film by fusion of acryl resin emulsion particles and therefore has a low finishing property (glossiness) after coating and that it is not reliable as compared with a solvent base coating system in the point that the coating film formed has an unsatisfactory gas-barrier property of oxygen and steam. Thus, required to be developed is a water-based coating system in which the same performance as in coating by a solvent type coating material is exhibited by coating a water-based coating material on the surface of metals.

On the other hand, coating material compositions comprising a water-based fatty acid-modified acryl resin having both of the functions of a water-based alkyd resin and a water-based acryl resin are disclosed in Japanese Patent Application Laid-Open No. 8773/1984 and Japanese Patent Application Laid-Open No. 319525/2000. It is described in the above publications that the above coating material compositions form coating films having an excellent corrosion resistance and is suited as a primer for a metal face. However, there is involved therein the problem that the coating films formed are unsatisfactory in a water resistance and a weatherability attributable to the fatty acid component which is a soft component, and mere coating of the above coating material compositions on the surface of a metal substrate can not sufficiently protect the surface of the metal over a long period of time.

### DISCLOSURE OF THE INVENTION

A principal object of the present invention is to provide a coating finishing method by a water-based coating material which shows a good finished appearance and which can maintain a fine view of metal surfaces used for structures such as buildings, bridges and plant facilities over a long period of time.

The present inventors have found that the object described above can be achieved by a coating finishing method in which a water-based under coating material is coated on a metal substrate and in which a water-based coating material comprising a water-based fatty acid-modified acryl resin having a specific average particle diameter as a base resin component and containing a pigment in a specific concentration is coated on the coated face thereof, and they have come to complete the present invention.

Thus, the present invention provides a coating finishing method comprising coating a water-based under coating material (I) on a surface of a metal substrate or an old coated face of a metal substrate and then coating on a coated surface thereof, a water-based coating material (II) comprising a water-based fatty acid-modified acryl resin as a base resin component, wherein the above water-based coating material (II) contains a pigment in a pigment volume concentration falling in a range of 5 to 45%, and the above water-based fatty acid-modified acryl resin has a form of a fine particle having an average particle diameter falling in a range of 50 to 500 nm.

The water-based coating material (II) used for the method of the present invention is excellent in a film-forming property and a glossiness and can provide the formed coating film with a gas-barrier property by the fatty acid component which is a soft component and cross-linking, and therefore it can inhibit gases such as steam and oxygen from reaching an under coating film. Further, bleeding of rust and a blistering phenomenon can be reduced by providing a coating film by the water-based under coating material (I), and therefore according to the present invention, a finished coating film which protects a metal face over a long period of time can be formed.

The method of the present invention shall be explained below in further details.

The substrate surface to which the method of the present invention can be applied includes the surfaces of metals such as iron, aluminum and the like and old faces on which coated are coating materials of an alkyd resin base, an acryl alkyd resin base, a silicon alkyd resin base, an acryl resin base, an acryl urethane resin base, a polyurethane resin base, a fluororesin base, a silicon acryl resin base, a vinyl acetate resin base and an epoxy resin base (hereinafter they shall be called “metal substrate surface” as a general term). The method of the present invention is particularly suited to finish coating of a steel substrate or an old coated face on the surface of a steel substrate.

In the method of the present invention, the water-based under coating material (I) is coated for the purpose of inhibiting corrosion on the surface of a metal substrate and bleeding of rust and controlling unevenness on a surface to be coated by providing a film between the surface of the metal substrate and a coating film formed by the water-based coating material (II) described later. A water-based under coating material and a base controlling agent which are conventionally known can be used as the water-based under coating material (I).

Various water-based resins which are conventionally known as those used for coating materials can be used as the base resin component in the water-based under coating material (I) described above, and capable of being given are, for example, acryl resins, urethane resins, epoxy resins, alkyd resins, fatty acid-modified acryl resins and fatty acid-modified epoxy resins. In the method of the present invention, at least one water-based resin selected from the group consisting of the alkyd resins, the fatty acid-modified acryl resins and the fatty acid-modified epoxy resins is preferably used from the viewpoint that they have a good compatibility with a metal face and are excellent as well in an adhesive property to a coating film given by the water-based coating material (II) described later.

The water-based under coating material (I) described above preferably contains a pigment in a higher pigment volume concentration than that of the water-based coating material (II) for the purposes of inhibiting blistering in the finally obtained multilayer coating film from being generated and controlling unevenness on a surface to be coated, and it preferably contains a pigment in a pigment volume concentration falling in a range of usually 30 to 50%, particularly 34 to 46%.

In this respect, the “pigment volume concentration” is a volume proportion of the above pigment based on the total solid matter of the whole resin components and the whole pigments contained in the coating material. In the present specification, a specific gravity of the pigment which is a ground for calculating a volume of the pigment is referred to Paint Raw Material Manual sixth edition edited by Japan Paint Industry Association, and it is assumed that a specific gravity of the resin is approximate to 1.

The pigment which is blended with the water-based under coating material (I) includes, for example, color pigments such as titanium white and red iron oxide; extender pigments such as calcium carbonate, magnesium silicate hydrate, talc, mica, clay and baryta; and rust preventive pigments such as phosphoric acid base pigments, and a phosphoric acid base pigment is preferably blended as a part of the pigment from the viewpoint of the corrosion resistance. Capable of being given as the phosphoric acid base pigment are, for example, zinc phosphate, phospho zinc silicate, aluminum zinc phosphate, calcium zinc phosphate, calcium phosphate, aluminum pyrophosphate, calcium pyrophosphate, aluminum tripolydihydrogenphosphate, aluminum metaphosphate, calcium metaphosphate, zinc phosphomolybdate and aluminum phosphomolybdate. They can be used alone or in combination of two or more kinds thereof A blending amount of the above phosphoric acid base pigment falls suitably in a range of 0.1 to 25%, preferably 1 to 20% in terms of a pigment volume concentration.

The water-based under coating material (I) described above can contain, if necessary, at least one of conventional additives for a coating material such as hydrazine derivatives described later, metal dryers, flash rust inhibitors, aldehyde scavengers, pigment dispersants, surface controlling agents, UV absorbers, defoaming agents, thickeners, curing catalysts, precipitation preventives, film-forming aids, antifreezing agents and antiseptic agents.

The water-based under coating material (I) described above can be coated in a coating amount falling in a range of usually 0.05 to 0.5 kg/m², preferably 0.08 to 0.3 kg/m², and it can be coated by means of a coating instrument such as a roller, an air spray, an airless spray, a lithin gun, a universal gun and a brush. The coating film thickness can fall in a range of usually 15 to 150 μm, preferably 24 to 90 μm in terms of a dry film thickness.

The drying conditions of the water-based under coating material (I) described above shall not specifically be restricted and can be changed according to the kind of the water-based under coating material, and it can be dried as well at a temperature of about 40° C. or less. The drying time at about 25° C. can be, for example, 1 to 720 hours, preferably 2 to 336 hours after coating.

The water-based coating material (II) coated on a surface on which the water-based under coating material (I) described above is coated according to the method of the present invention contains as a base resin component, a water-based fatty acid-modified acryl resin having a form of a fine particle having an average particle diameter falling in a range of 50 to 500 nm, particularly 75 to 400 nm and further particularly 100 to 250 nm. If the water-based fatty acid-modified acryl resin has an average particle diameter of less than 50 nm, not only the coating material is increased in a viscosity to make it difficult to form a smooth coating film, but also the state of the coating material after storage at a low temperature is reduced. On the other hand, if the average particle diameter exceeds 500 nm, a storage stability of the coating material becomes unsatisfactory, and the film-forming property is reduced. Further, the coating film formed is reduced as well in a gas-barrier property, and therefore the above is not preferred. In the present specification, the average particle diameter is a value obtained by measuring the sample diluted to a concentration suited to the measurement with deionized water at a room temperature (about 20° C.) by means of “SALD-3100” (trade name, a laser diffraction type particle size distribution measuring apparatus, manufactured by Shimadzu Mfg. Co., Ltd.).

Suited as the water-based fatty acid-modified acryl resin described above is, for example, a resin comprising a structural unit derived from a fatty acid (a), an epoxy group-containing polymerizable unsaturated monomer (b), an acid group-containing polymerizable unsaturated monomer (c), a polymerizable unsaturated monomer (d) having an alkyl group having 4 or more carbon atoms and the other polymerizable unsaturated monomer (e).

The fatty acid (a) includes fatty acids having a structure in which a carboxyl group is bonded to an end of a hydrocarbon chain, and drying oil fatty acids, semi-drying oil fatty acids and non-drying oil fatty acids can be given as the examples thereof. The drying oil fatty acids can not strictly be distinguished from the semi-drying oil fatty acids. In general, the drying oil fatty acids are unsaturated fatty acids having an iodine value of 130 or more, and the semi-drying oil fatty acids are unsaturated fatty acids having an iodine value of 100 or more and less than 130. Further, in general, the non-drying oil fatty acids are unsaturated fatty acids having an iodine value of less than 100. The drying oil fatty acids and the semi-drying oil fatty acids include, for example, fish oil fatty acid, dehydrated castor oil fatty acid, safflower oil fatty acid, linseed oil fatty acid, soybean oil fatty acid, sesame oil fatty acid, proppy seed oil fatty acid, perila oil fatty acid, hemp-seed oil fatty acid, grape nucleus oil fatty acid, corn oil fatty acid, tall oil fatty acid, sunflower oil fatty acid, cotton seed oil fatty acid, walnut oil fatty acid and sesame seed oil fatty acid. The non-drying oil fatty acids include, for example, coconut oil fatty acids, hydrogenated coconut oil fatty acids and palm oil fatty acids. They can be used alone or in combination of two or more kinds thereof. Caproic acid, capric acid, lauric acid, myristic acid, palmitic acid and stearic acid can be used in combination therewith.

In the present invention, the drying oil fatty acid and/or the semi-drying oil fatty acid are suitably used as the fatty acid (a) because of an excellent oxidation curing property and an excellent gas-barrier property of the coating film formed.

The epoxy group-containing polymerizable unsaturated monomer (b) includes monomers having one epoxy group and one polymerizable unsaturated bond in a molecule, and it includes, for example, glycidyl (meth)acrylate, B-methylglycidyl (meth)acrylate, 3,4-epoxycyclohexylmethyl (meth)acrylate, 3,4-epoxycyclohexylethyl (meth)acrylate, 3,4-epoxycyclohexylpropyl (meth)acrylate and allyl glycidyl ether. They can be used alone or in combination of two or more kinds thereof.

The acid group-containing polymerizable unsaturated monomer (c) includes monomers having one acid group and one polymerizable unsaturated bond in a molecule, and it includes, for example, polymerizable unsaturated monomers having a carboxyl group such as (meth)acrylic acid, maleic acid, crotonic acid and β-carboxyethyl acrylate; and polymerizable unsaturated monomers having at least one group selected from the group consisting of a sulfonic acid group, a sulfonate group, a phosphoric acid group and a phosphate group which are represented by the following formulas:

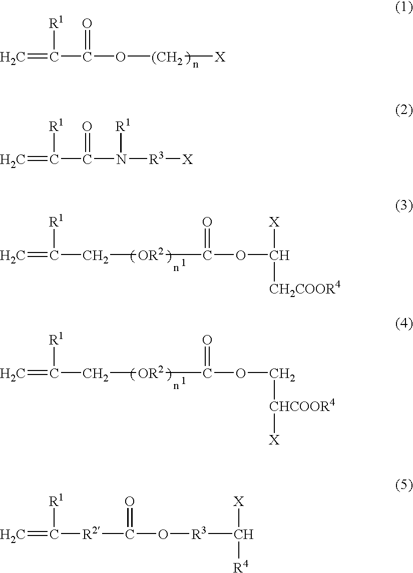

wherein R¹ represents hydrogen or methyl;

R² represents an alkylene group having 2 to 4 carbon atoms which may have a substituent if necessary, preferably ethylene or propylene;

R² represents an alkylene group having 1 to 20 carbon atoms, preferably 2 to 4 carbon atoms which may have a substituent if necessary;

R³ represents an alkylene group having 1 to 6 carbon atoms, preferably 2 or 3 carbon atoms which may have a substituent if necessary;

R⁴ represents a monovalent organic group having a saturated or unsaturated alkyl group or an oxyalkylene group which may have a substituent if necessary;

X represents a group selected from the group consisting of a sulfonic acid group, a sulfonate group, a phosphoric acid group and a phosphate group;

n is an integer, preferably an integer of 1 to 20; and

n¹ is an integer, preferably an integer of 1 to 20.

Capable of being given as the polymerizable unsaturated monomer (d) having an alkyl group having 4 or more carbon atoms are, for example, alkyl or cycloalkyl (meth)acrylate such as n-butyl (meth)acrylate, i-butyl (meth)acrylate, tert-butyl (meth)acrylate, n-hexyl (meth)acrylate, octyl (meth)acrylate, 2-ethylhexyl (meth)acrylate, nonyl (meth)acrylate, tridecyl (meth)acrylate, lauryl (meth)acrylate, C₁₈-alkyl (meth)acrylate such as stearyl (meth)acrylate and “Iso Stearyl Acrylate” (trade name, manufactured by Osaka Organic Chemical Co., Ltd), cyclohexyl (meth)acrylate, methylcyclohexyl (meth)acrylate, tert-butylcyclohexyl (meth)acrylate and cyclododecyl (meth)acrylate. They can be used alone or in combination of two or more kinds thereof. Among these polymerizable unsaturated monomers (d), suited are monomers containing as a part thereof, a polymerizable unsaturated monomer having a linear or branched hydrocarbon group having 6 or more carbon atoms and/or a polymerizable unsaturated monomer having a cycloalkyl group.

The other polymerizable unsaturated monomer (e) is a monomer component which is copolymerizable with the monomers (b), (c) and/or (d) each described above and includes, for example, (meth)acrylates such as methyl (meth)acrylate, ethyl (meth)acrylate, n-propyl (meth)acrylate and i-propyl (meth)acrylate; polymerizable unsaturated monomers having an isobornyl group such as isobornyl (meth)acrylate; polymerizable unsaturated monomers having an adamantyl group such as adamantyl (meth)acrylate; vinyl aromatic compounds such as styrene, α-methylstyrene and vinyltoluene; polymerizable unsaturated monomers having an alkoxysilyl group such as vinyltrimethoxysilane, vinyltriethoxysilane, vinyltris(2-methoxyethoxy)silane, y-(meth)acryloyloxypropyl-trimethoxysilane and y-(meth)acryloyloxypropyl-triethoxysilane; perfluoroalkyl (meth)acrylates such as perfluorobutylethyl (meth)acrylate and perfluorooctylethyl (meth)acrylate; polymerizable unsaturated monomers having a fluoroalkyl group such as fluoroolefin; polymerizable unsaturated monomers having a photopolymerizable functional group such as a maleimide group; 1,2,2,6,6-pentamethylpiperidinyl (meth)acrylate and 2,2,6,6-tetrtamethylpiperidinyl (meth)acrylate; vinyl compounds such as N-vinylpyrrolidone, ethylene, butadiene, chloroprene, vinyl propionate and vinyl acetate; nitrogen-containing polymerizable unsaturated monomers such as (meth)acrylonitrile, (meth)acrylamide, dimethylaminopropyl(meth)acrylamide, dimethylaminoethyl (meth)acrylate and adducts of glycidyl (meth)acrylate and amines; (meth)acrylates having a hydroxyl group including hydroxyalkyl esters having 2 to 8 carbon atoms with (meth)acrylic acid such as 2-hydroxyethyl (meth)acrylate, 2-hydroxypropyl (meth)acrylate, 3-hydroxypropyl (meth)acrylate and hydroxybutyl (meth)acrylate, allyl alcohol and ε-caprolactone-modified products of the hydroxyalkyl esters having 2 to 8 carbon atoms with (meth)acrylic acid described above; polymerizable unsaturated monomers having a hydroxyl group such as (meth)acrylates having a polyoxyethylene chain having a hydroxyl group at a molecular end; addition reaction products of hydroxybenzophenones with glycidyl (meth)acrylate such as 2-hydroxy-4-(3-methacryloyloxy-2-hydroxypropoxy)benzophenone, 2-hydroxy-4-(3-acryloyloxy-2-hydroxypropoxy)benzophenone, 2,2′-dihydroxy-4-(3-methacryloyloxy-2-hydroxypropoxy)benzophenone, 2,2′-dihydroxy-4(3-acryloyloxy-2-hydroxypropoxy)benzophenone, 2,4-dihydroxybenzophenone and 2,2′, 4-trihydroxybenzophenone; polymerizable unsaturated monomers having a UV-absorbing functional group such as 2-(2′-hydroxy-5′-methacryloyloxyethylphenyl)-2H-benzotriazole; UV-stabilizing unsaturated monomers such as 4-(meth)acryloyloxy-1,2,2,6,6-pentamethylpiperidine, 4-(meth)acryloyloxy-2,2,6,6-tetramethylpiperidine, 4-cyano-4-(meth)acryloylamino-2,2,6,6-tetramethylpiperidine, 1-(meth)acryloyl-4-(meth)acryloylamino-2,2,6,6-tetramethylpiperidine, 1-(meth)acryloyl-4-cyano-4-(meth)acryloylamino-2,2,6,6-tetramethylpiperidine, 4-crotonoyloxy-2,2,6,6-tetramethylpiperidine, 4-crotonoylamino-2,2,6,6-tetramethylpiperidine and 1-crotonoyl-4-crotonoyloxy-2,2,6,6-tetramethylpiperidine; polymerizable unsaturated monomers having a carbonyl group such as acrolein, diacetonacrylamide, diacetonemethacrylamide, acetoacetoxyethyl methacrylate, formylstyrol and vinyl alkyl ketones having 4 to 7 carbon atoms (for example, vinyl methyl ketone, vinyl ethyl ketone and vinyl butyl ketone); and multivinyl compounds having at least two polymerizable unsaturated groups in a molecule such as allyl (meth)acrylate, ethylene glycol di(meth)acrylate, triethylene glycol di(meth)acrylate, tetraethylene glycol di(meth)acrylate, 1,3-butylene glycol di(meth)acrylate, trimethylolpropane tri(meth)acrylate, 1,4-butanediol di(meth)acrylate, neopentyl glycol di(meth)acrylate, 1,6-hexanediol di(meth)acrylate, pentaerythritol di(meth)acrylate, pentaerythritol tetra(meth)acrylate, glycerol di(meth)acrylate, 1,1,1-trishydroxymethylethane di(meth)acrylate, 1,1,1-trishydroxymethylethane tri(meth)acrylate, 1,1,1-trishydroxymethylpropane tri(meth)acrylate, triallyl isocyanurate, diallyl terephthalate and divinylbenzene. They are suitably selected according to performances required to the resin formed and can be used alone or in combination of two or more kinds thereof.

The water-based fatty acid-modified acryl resin described above can be obtained by copolymerizing the fatty acid (a), the epoxy group-containing polymerizable unsaturated monomer (b), the acid group-containing polymerizable unsaturated monomer (c), the polymerizable unsaturated monomer (d) having an alkyl group having 4 or more carbon atoms and the other polymerizable unsaturated monomer (e) each described above. A use proportion of the respective components can be set as follows based on the total amounts of the components (a), (b), (c), (d) and (e): component (a): 0.5 to 40% by weight, preferably 3 to 37% by weight and particularly preferably 7 to 33% by weight, component (b): 0.3 to 20% by weight, preferably 1.5 to 18.5% by weight and particularly preferably 3.5 to 16.5% by weight, component (c): 0.1 to 5% by weight, preferably 0.3 to 4.5% by weight and particularly preferably 0.5 to 4.0% by weight, component (d): 20 to 95% by weight, preferably 25 to 85% by weight and particularly preferably 30 to 75% by weight.

The water-based fatty acid-modified acryl resin described above can suitably be produced by subjecting the fatty acid (a) and the epoxy group-containing polymerizable unsaturated monomer (b) to addition reaction and then copolymerizing the resulting fatty acid-modified polymerizable unsaturated monomer with the acid group-containing polymerizable unsaturated monomer (c), the polymerizable unsaturated monomer (d) having an alkyl group having 4 or more carbon atoms and the other polymerizable unsaturated monomer (e).

In producing the fatty acid-modified polymerizable unsaturated monomer described above, the fatty acid (a) is suitably reacted with the epoxy group-containing polymerizable unsaturated monomer (b) in such a proportion that an equivalent ratio of a carboxyl group in the above fatty acid (a) to an epoxy group in the epoxy group-containing polymerizable unsaturated monomer (b) falls in a range of usually 0.75: 1 to 1.25: 1, preferably 0.8: 1 to 1.2: 1.

The fatty acid (a) can be reacted with the epoxy group-containing polymerizable unsaturated monomer (b) in the presence of a polymerization inhibitor described later according to a conventional method on such conditions that a carboxyl group in the fatty acid component can smoothly be reacted with an epoxy group in the epoxy group-containing polymerizable unsaturated monomer without bringing about problems on reaction such as gelation. They are suitably reacted on the condition that they are heated usually at about 100 to about 180° C. for about 0.5 to about 10 hours.

In this reaction, capable of being used is, for example, an esterification catalyst including tertiary amine such as N,N-dimethylaminoethanol and a quaternary ammonium salt such as tetraethylammonium bromide and tetrabutylammonium bromide, and an organic solvent which is inert to the reaction may be present.

The polymerization inhibitor described above includes, for example, publicly known radical polymerization inhibitors including hydroxy compounds such as hydroquinone, hydroquinone monomethyl ether, pyrocatechol and p-tert-butylpyrocatechol; nitro compounds such as nitrobenzene, nitrobenzoic acid, o-, m- or p-dinitrobenzene, 2,4-dinitrotoluene, 2,4-dinitrophenol, trinitrobenzene and picric acid; quinone compounds such as p-benzoquinone, dichlorobenzoquinone, chloroanil, anthraquinone and phenanthroquinone; and nitroso compounds such as nitrosobenzene and nitroso-B-naphthol. They can be used alone or in combination of two or more kinds thereof.

The water-based fatty acid-modified acryl resin can be produced, for example, by subjecting the fatty acid-modified polymerizable unsaturated monomer obtained in the manner described above to solution polymerization with the acid group-containing polymerizable unsaturated monomer (c), the polymerizable unsaturated monomer (d) having an alkyl group having 4 or more carbon atoms and the other polymerizable unsaturated monomer (e) in an organic solvent in the presence of a polymerization initiator.

In respect to the use proportions of the respective monomers based on the total amount of the monomers, that of the fatty acid-modified polymerizable unsaturated monomer is 0.8 to 60% by weight, preferably 4.5 to 55.5% by weight and particularly preferably 10.5 to 49.5% by weight; that of the monomer (c) is 0.1 to 5% by weight, preferably 0.3 to 4.5% by weight and particularly preferably 0.5 to 4.0% by weight; and that of the monomer (d) is 20 to 95% by weight, preferably 25 to 85% by weight and particularly preferably 30 to 75% by weight.

The polymerizable unsaturated monomer (d) having an alkyl group having 4 or more carbon atoms described above preferably contains, as described above, the polymerizable unsaturated monomer having a linear or branched hydrocarbon group having 6 or more carbon atoms at least as a part thereof from the viewpoints of a water resistance of the coating film formed and a production stability of the water-based fatty acid-modified acryl resin. Capable of being given as the polymerizable unsaturated monomer having a linear or branched hydrocarbon group having 6 or more carbon atoms are, for example, n-hexyl (meth)acrylate, octyl (meth)acrylate, 2-ethylhexyl (meth)acrylate, nonyl (meth)acrylate, tridecyl (meth)acrylate, lauryl (meth)acrylate, C₁₈-alkyl (meth)acrylate such as stearyl (meth)acrylate and “Isostearyl Acrylate” (trade name, manufactured by Osaka Organic Chemical Co., Ltd.). They can be used alone or in combination of two or more kinds thereof. The polymerizable unsaturated monomer having an alkyl group having 6 or more carbon atoms is used preferably in a range of 1 to 30% by weight, preferably 3 to 27% by weight and more preferably 5 to 24% by weight based on the total amount of the components (a), (b), (c), (d) and (e).

The polymerizable unsaturated monomer (d) having an alkyl group having 4 or more carbon atoms preferably contains, as described above, the polymerizable unsaturated monomer having a cycloalkyl group at least as a part thereof. Use of the above monomer makes it possible to elevate a weatherability and a water resistance of the coating film formed. Capable of being given as the polymerizable unsaturated monomer having a cycloalkyl group are, for example, cyclohexyl (meth)acrylate, methylcyclohexyl (meth)acrylate, t-butylcyclohexyl (meth)acrylate and cyclododecyl (meth)acrylate, and they can be used alone or in combination of two or more kinds thereof. The polymerizable unsaturated monomer having a cycloalkyl group is used suitably in a range of 10% by weight or more, preferably 20 to 60% by weight and more preferably 25 to 45% by weight based on the total amount of the components (a), (b), (c), (d) and (e).

The other polymerizable unsaturated monomer (e) preferably contains at least as a part thereof, a carbonyl group-containing polymerizable unsaturated monomer as a copolymerization component. The carbonyl group-containing polymerizable unsaturated monomer includes, for example, acrolein, diacetonacrylamide, diacetonemethacrylamide, acetoacetoxyethyl methacrylate, formylstyrol and vinyl alkyl ketones having 4 to 7 carbon atoms (for example, vinyl methyl ketone, vinyl ethyl ketone and vinyl butyl ketone). They can be used alone or in combination of two or more kinds thereof.

Use of the monomer containing the carbonyl group-containing polymerizable unsaturated monomer as the other polymerizable unsaturated monomer (e) makes it possible to promote auxiliary cross-linking of the above carbonyl group with a hydrazine derivative described later in addition to oxidation curing by the fatty acid (a) component by using in combination with the above hydrazine derivative and makes it possible to elevate further more a gas-barrier property of the coating film and obtain a coating material providing a coating film which is excellent in physical properties such as a weatherability and a water resistance. In this case, semi-drying oil fatty acids and/or non-drying oil fatty acids each having a low oxidation curing property can be used as the fatty acid (a).

The above carbonyl group-containing polymerizable unsaturated monomer is used suitably in a range of 0.5 to 35% by weight, preferably 1 to 30% by weight and more preferably 2 to 20% by weight based on the total amount of the components (a), (b), (c), (d) and (e).

The other polymerizable unsaturated monomer (e) preferably contains a vinyl aromatic compound at least as a part thereof. This makes it possible to enhance a copolymerizing property between the monomers and provide the resulting fatty acid-modified acryl resin with a water resistance. The above vinyl aromatic compound is used suitably in a range of 1 to 50% by weight, preferably 5 to 45% by weight and more preferably 12 to 35% by weight based on the total amount of the components (a), (b), (c), (d) and (e).

The water-based fatty acid-modified acryl resin described above can be produced by dispersing the mixture of all the polymerizable unsaturated monomers described above in an aqueous medium so that an average particle diameter falls in a range of 500 nm or less, for example, 50 to 500 nm, particularly 75 to 400 nm and more particularly 100 to 250 nm and then polymerizing them.

Further, the water-based fatty acid-modified acryl resin described above can be produced as well by a method in which all the polymerizable unsaturated monomers described above are copolymerized in an organic solvent and in which the resulting copolymer is neutralized by a neutralizing agent to be solubilized in water or dispersed in water, a method in which this is further dispersed in an aqueous medium by means of a disperser having a high energy shearing ability and a method in which all the polymerizable unsaturated monomers described above are subjected to seed emulsion polymerization in the presence of water and an emulsifier. Further, the polymerization may be carried out in the presence of a chain transfer agent for the purpose of controlling a weight average molecular weight of the resulting copolymer.

The water-based fatty acid-modified acryl resin described above has preferably a weight average molecular weight falling in a range of usually 10,000 to 500,000, particularly 30,000 to 200,000. If the above resin has a weight average molecular weight of less than 10,000, the finally obtained coating film is reduced in a weatherability and a water resistance in a certain case. On the other hand, if it exceeds 500,000, the particle of the above resin is reduced in a film-forming property, and the coating film formed by the water-based coating material is reduced in a barrier property in a certain case. In this case, the weight average molecular weight is a value obtained by reducing a molecular weight measured by gel permeation chromatography using tetrahydrofuran as a solvent based on a molecular weight of polystyrene. “TSK gel G-4000H×L”, “TSK gel G-3000H×L”, “TSK gel G-2500H×L” and “TSK gel G-2000H×L” (all manufactured by Toso Co., Ltd.) can be given as a column used for the above gel permeation chromatography.

The water-based fatty acid-modified acryl resin described above has preferably an oil length falling in a range of 0.5 to 40%, particularly 3 to 37% and more particularly 7 to 33%. In the present specification, the oil length is a proportion of a weight of the fatty acid to a weight of the resin solid matter. If the above resin has an oil length of less than 0.5%, the oxidation curing property is unsatisfactory. On the other hand, if it exceeds 40%, the coating film formed becomes hard and fragile with the passage of time in a dry state and it is inferior in performances such as a weatherability and an alkali resistance.

The water-based coating material (II) used for the method of the present invention comprises the water-based fatty acid-modified acryl resin described above as a base resin, and it further comprises preferably a hydrazine derivative in addition thereto. To be specific, the above derivative includes, for example, saturated carboxylic acid dihydrazide having 2 to 18 carbon atoms such as oxalic acid dihydrazide, malonic acid dihydrazide, glutaric acid dihydrazide, succinic acid dihydrazide, adipic acid dihydrazide and sebacic acid dihydrazide; monoolefinic unsaturated dicarboxylic acid dihydrazide such as maleic acid dihydrazide, fumaric acid dihydrazide and itaconic acid dihydrazide; phthalic acid dihydrazide, terephthalic acid dihydrazide or isophthalic acid dihydrazide, dihydrazide, trihydrazide or tetrahydrazide of pyromellitic acid; nitrilotrihydrazide, citroyl trihydrazide, 1,2,4-benzenetrihydrazide, ethylenediaminetetracetic acid tetrahydrazide, 1,4,5,8-naphtic acid tetrahydrazide; polyhydrazide obtained by reacting a low polymer having a carboxylic acid lower alkyl ester group with hydrazine or hydrazine hydrate; compounds having a hydrazide group such as carbonoyl dihydrazide; bissemicarbazide; diisocyanates such as hexamethylenediisocyanate and isophoronediisocyanate and multifunctional semicarbazides obtained by reacting polyisocyanate compounds derived from the above diisocyanates with N,N-substituted hydrazines such as N,N-dimethylhydrazine and the hydrazides given above as the examples in excess; aqueous multifunctional semicarbazides obtained by reacting the hydrazides given above as the examples in excess with isocyanate groups contained in reaction products of the above polyisocyanate compounds with polyethers and active hydrogen compounds having a hydrophilic group such as polyols and polyethylene glycol monoalkyl ethers; compounds having a semicarbazide group such as mixtures of the above multifunctional semicarbazides and the above aqueous multifunctional semicarbazides and compounds having a hydrazone group such as bisacetyldihydrazone.

Addition of the hydrazine derivatives described above to the water-based coating material (II) makes it possible to allow the coating film formed to absorb and remove harmful substances in the air, for example, formaldehyde, and therefore they are useful. When the water-based fatty acid-modified acryl resin has a carbonyl group, they can act as a cross-linking agent for auxiliary cross-linking.

A blending amount of the hydrazine derivatives described above falls preferably in a range of 0.01 to 10% by weight, particularly 0.1 to 5% by weight.

The water-based coating material (II) contains preferably at least one compound selected from the group consisting of nitrites, phytates, tannates, phosphates and polyamine compounds. The nitrites include, for example, sodium nitrite, calcium nitrite, strontium nitrite, barium nitrite and ammonium nitrite. The phytates include, for example, sodium phytate and potassium phytate. The tannates include, for example, sodium tannate and potassium tannate. The polyamine compounds include, for example, N-(2-hydroxyethyl)-ethylenediaminetriacetic acid (HEDTA), ethylenediamine-tetraacetic acid (EDTA), diethylenediaminepentaacetic acid (DTPA), propylenediaminetetraacetic acid (PDTA), iminodiacetic acid, nitrilotriacetic acid (NTA), diethylenetriaminepentamethylenephosphonic acid (DTPMP) and alkaline metal salts thereof, and intercalation compounds obtained by intercalating monoalkylamines, polyamines and quaternary ammonium ions into stratified phosphates such as aluminum tripolydihydrogenphosphate. They can be used alone or in combination of two or more kinds thereof.

Addition of the above basic compounds makes it possible to prevent rusts generated from a metal face from bleeding onto the surface of a coating film formed by the water-based coating material (II) to produce dotted rusts even if the rusts generated pass through a coating film formed by the water-based under coating material (I) to reach the coating film formed by the water-based coating material (II). An addition amount of the basic compounds described above falls suitably in a range of 0.02 to 2% by weight, preferably 0.05 to 1% by weight based on the weight of the water-based coating material (II).

The water-based coating material (II) used for the method of the present invention contains a pigment in a pigment volume concentration of 5 to 45% and preferably contains it in a pigment volume concentration falling in a range of particularly 10 to 35%, further particularly 14 to 30%. If the pigment volume concentration is less than 5%, the coating film formed is unsatisfactory in a hiding power in a certain case. On the other hand, if it exceeds 45%, the coating film formed is reduced in a finishing property as well as a barrier property in a certain case.

Capable of being given as the pigment which can be blended with the water-based coating material (II) are, for example, color pigments such as titanium white and red iron oxide; extender pigments such as calcium carbonate, magnesium silicate hydrate, talc, mica, clay and baryta; and rust protective pigments such as the phosphoric acid base pigments described above.

The water-based coating material (II) described above can contain a metal dryer as a catalyst for accelerating oxidation curing. The above metal dryer includes, for example, salts of acids with at least one metal selected from the group consisting of aluminum, calcium, cerium, cobalt, iron, lithium, magnesium, manganese, zinc, and zirconium, and the above acids include, for example, capric acid, caprylic acid, isodecanoic acid, linolenic acid, naphthenic acid, neodecanoic acid, octeic acid, oleic acid, palmitic acid, resin acid, ricinolic acid, soybean oil fatty acid, stearic acid and tall acid fatty acid.

The water-based coating material (II) described above can contain a combination of those suitably selected from additives for a coating material including resins for modification such as water soluble or emulsion type acryl resins, alkyd resins, silicon resins, fluororesins, epoxy resins, urethane resins and polyester resins, surface controlling agents, UV absorbers, UV stabilizers, pigment dispersants, surfactants, defoaming agents, thickeners, film-forming aids, antiseptic agents, anti-mold agents, antifreezing agents, pH controlling agents, flash rust inhibitors, aldehyde scavengers, stratified clay minerals, powder or fine particle activated carbons, photocatalyst titanium oxide and contamination-reducing agents such as polyalkylene glycol-modified alkyl silicates.

The water-based coating material (II) described above is excellent in a gas-barrier property of the coating film formed, and to be specific, it can form a coating film having a water vapor permeability of 400 g/m²·24 hr or less, particularly 350 g/m²·24 hr or less. In the present specification, the permeability can be measured according to JIS Z 0208. To be specific, an optimum amount of anhydrous calcium chloride is put into a vessel, and a test coating film is adhered to an aperture part of the vessel by means of a sealing wax agent to prepare a test matter for measuring a water vapor permeability. This test matter is left standing still on the conditions of a temperature of 40° C. and a relative humidity of 95±2% for 24 hours to measure a change in the weight thereof, whereby a mass of water vapor permeating per m² of the test coating film is calculated. Used as the test coating film is a free coating film having no pin holes obtained by coating the coating material on a mold releasing paper by means of a film applicator or an air spray so that a dried film thickness is 40 to 50 μm. In coating, the coating material is preferably controlled to a viscosity of 80 KU or more and defoamed, if necessary, by means of a defoaming machine, and then it is coated. The drying condition is 14 days on the conditions of a temperature of 20° C. and a relative humidity of 60%. The drying condition until the test after coating is 2 weeks at a temperature of 20 to 25° C. and a relative humidity of 75% RH or less.

The water-based coating material (II) described above is controlled so that a solid matter concentration of the coating material falls in a range of 30 to 70% by weight, preferably 40 to 60% by weight, and then it is coated so that a coating amount per one coating falls in a range of 0.05 to 0.5 kg/m², preferably 0.08 to 0.3 kg/m² and more preferably 0.1 to 0.2 kg/m².

The coating can be carried out by means of a coating instrument such as a roller, an air spray, an airless spray, a lithin gun, a universal gun and a brush, and the coating is carried out preferably by means of a roller, an air spray, an airless spray, a lithin gun and a universal gun in order to obtain the high finish.

The coating film is cured usually for 2 to 24 hours at about 25° C.

### EXAMPLES

The present invention shall more specifically be explained below with reference to examples. “Parts” and “%” are “parts by weight” and “% by weight”.

Production of Fatty Acid-Modified Polymerizable Unsaturated Monomer

### Production Example 1

The following components were put into a reactor and reacted at a reaction temperature of 140° C. while stirring to obtain a fatty acid-modified monomer (a-1). The reaction of the epoxy group with the carbonyl group was monitored by measuring an amount of the remaining carbonyl group. About 5 hours were required until the reaction was completed.

| | |
|---|---|
| Safflower oil fatty acid | 280 parts |
| Glycidyl methacrylate | 142 parts |

### Production Example 2

A fatty acid-modified monomer (a-2) was obtained in the same manner as in Production Example 1, except that the components to be reacted were changed as shown below.

| | |
|---|---|
| Linseed oil fatty acid | 280 parts |
| Glycidyl methacrylate | 142 parts |

### Production Example 3

A fatty acid-modified monomer (a-3) was obtained in the same manner as in Production Example 1, except that the components to be reacted were changed as shown below.

| | |
|---|---|
| Coconut oil fatty acid | 210 parts |
| Glycidyl methacrylate | 142 parts |

Production of Water-Based Fatty Acid-Modified Acryl Resin

### Production Example 4

The following components were put into a glass beaker and stirred at 2000 rpm for 15 minutes by means of a disper to produce a preliminary emulsion, and then this preliminary emulsion was subjected to high pressure treatment at 100 MPa by means of a high pressure emulsifying apparatus in which a high pressure energy was applied to allow fluids to collide with each other, whereby a monomer emulsion having an average particle diameter of 190 nm was obtained.

Monomer Emulsion Composition

| | |
|---|---|
| Fatty acid-modified monomer (a-1) | 30 parts |
| n-Butyl methacrylate | 25 parts |
| i-Butyl methacrylate | 27 parts |
| 2-Ethylhexyl methacrylate | 17 parts |
| Methacrylic acid | 1 part |
| n-Octyl-3-mercaptopropionate | 0.5 part |
| “Newcol 707SF” (remark 1) | 10 parts |
| Deionized water | 85 parts |

Next, the monomer emulsion described above was transferred to a flask and diluted with deionized water so that a solid matter concentration was 45%. Then, the temperature was elevated up to 85° C., and an initiator aqueous solution prepared by dissolving 2 g of “VA-086” (remark 2) in 10 g of deionized water was added to the flask and stirred for 3 hours while maintaining the above temperature. Then, an initiator aqueous solution prepared by dissolving 0.5 g of “VA-086” (remark 2) in 10 g of deionized water was added thereto and stirred for one hour while maintaining the above temperature, and the solution was then cooled down to 40° C. and controlled to a pH of 8.0 with dimethylaminoethanol to obtain a water-based fatty acid-modified acryl resin (1-1) having a solid matter concentration of 40% and an average particle diameter of 185 nm.

(Remark 1) “Newcol 707SF”: trade name, manufactured by Nippon Emulsifier Co., Ltd., ammonium polyoxyethylenealkylbenzenesulfonate, active ingredient: 30%

(Remark 2) “A-086”: trade name, manufactured by Wako Pure Chemical Industries, Ltd., 2,2′-azobis[2-methyl-N-(2-hydroxyethyl)-propionamide]

### Production Examples 5 to 8

Water-based fatty acid-modified acryl resins (I-2) to (I-5) were obtained in the same manner as in Production Example 4, except that the monomer composition was changed as described in Table 1.

### Production Example 9

A four neck flask equipped with a stirrer, a thermometer, a reflux tube and an inert gas-introducing tube was charged with 500 parts of “Swazol 310” (remark 3) and heated up to 120° C. while allowing nitrogen gas to pass through under stirring. Then, dropwise added in 3 hours while maintaining the temperature at 120° C. was a mixture of

| | |
|---|---|
| fatty acid-modified monomer (a-1) | 260 parts |
| styrene | 150 parts |
| n-butyl methacrylate | 86 parts |
| i-butyl methacrylate | 86 parts |
| 2-ethylhexyl acrylate | 90 parts |
| “TBAS-Q” (remark 4) | 28 parts |
| azobisisobutyronitrile | 2.1 parts |

Then, the solution was ripened at 120° C. for 2 hours to obtain a brown, transparent fatty acid-modified acryl resin solution having a non-volatile matter content of 58%.

(Remark 3) “Swazol 310”: trade name, manufactured by Cosmo Petroleum Co., Ltd., mineral spirit

(Remark 4) “TBAS-Q”: trade name, manufactured by MRC Unitec Co., Ltd., comprising a compound represented by the following formula as a principal component:

CH₂═CH—CO—NH—C(CH₃)₂—CH₂—SO₃H.

The fatty acid-modified acryl resin solution described above was subjected to reduced pressure treatment to remove the solvent, and 10.9 g of triethylamine as a neutralizing agent was added to 875 g of the resin which was controlled to a non-volatile matter content of 80%. Then, the mixture was stirred at a high speed while gradually adding 700 g of deionized water to be preliminarily emulsified, and the above preliminary emulsion was subjected to high pressure treatment at a high pressure of 130 MPa by means of a high pressure emulsifying apparatus in which a high pressure energy was applied to allow fluids to collide with each other. A water-based fatty acid-modified acryl resin (1-6) having an average particle diameter of 200 nm and a solid matter content of 44% was obtained by repeating twice the above pass.

### Production Example 10

A water-based acryl resin (I-7) was obtained in the same manner as in Production Example 4, except that the monomer composition was changed as described in Table 1.

### Production Example 11

A water-based fatty acid-modified acryl resin (I-8) having an average particle diameter of 630 nm was obtained in the same blend composition and procedure as in Production Example 3, except that in Production Example 4, the resulting preliminary emulsion was stirred at 10000 rpm for 5 minutes by means of a disperser having a high shearing ability to obtain a monomer emulsion having an average particle diameter of 520 nm.

The monomer compositions and the property values of the respective fatty acid-modified acryl resins are shown in Table 1.

TABLE 1

| | Production Example | | | | | | | |
|---|---|---|---|---|---|---|---|---|
| | 4 | 5 | 6 | 7 | 8 | 9 | 10 | 11 |
| | I-1 | I-2 | I-3 | I-4 | I-5 | I-6 | I-7 | I-8 |
| Fatty acid-modified monomer (a-1) | 30 | | | | | 260 | | 30 |
| Fatty acid-modified monomer (a-2) | | 45 | 30.15 | 30.15 | | | | |
| Fatty acid-modified monomer (a-3) | | | | | 33.3 | | | |
| Styrene | | 15 | 15 | 15 | 15 | 150 | | |
| n-Butyl methacrylate | 25 | 10 | | | | 86 | 35 | 25 |
| i-Butyl methacrylate | 27 | 5 | 20.35 | | 24.7 | 86 | 35 | 22 |
| t-Butyl methacrylate | | | 20 | 10.35 | | | | |
| Hydroxyethyl acrylate | | | 4.5 | 4.5 | | | | |
| 2-Ethylhexyl methacrylate | 17 | 19 | 8 | 8 | 20 | 90 | 29 | 17 |
| Diacetonacrylamide | | 5 | | | 5 | | | 5 |
| Methacrylic acid | 1 | 1 | 2 | 2 | 2 | | 1 | 1 |
| Cyclohexyl methacrylate | | | | 30 | | | | |
| “TBAS-Q” (remark 4) | | | | | | 28 | | |
| n-Octyl-3-mercaptopropionate | 0.5 | 0.5 | 0.3 | | 0.3 | | 0.5 | 0.5 |
| Average particle diameter | 185 nm | 185 nm | 185 nm | 180 nm | 185 nm | 200 nm | 200 nm | 630 nm |
| Acid value | 6.5 | 6.5 | 13 | 13 | 13 | 10.8 | 6.5 | 6.5 |
| Solid matter content | 40% | 40% | 40% | 40% | 40% | 44% | 40% | 40% |

Production of Water-Based Coating Material

### Production Examples 12 to 21

A vessel was charged in order with the respective components shown in Composition (A) of Table 2, and the mixture was continued to be stirred for 30 minutes by means of a disper until it became homogeneous to obtain the respective pigment pastes. Then, the respective components shown in Composition (B) of Table 2 were added in order to the above respective pigment pastes to obtain the respective water-based coating materials. The water vapor permeabilities of coating films formed by the respective coating materials and the property values of the above coating materials are shown in Table 2.

TABLE 2

| | | | Production Example | | | | |
|---|---|---|---|---|---|---|---|
| | | | 12 | 13 | 14 | 15 | 16 |
| A | Clean water | | 10.0 | 12.0 | 10.0 | 10.0 | 10.0 |
| | Ethylene glycol | | 0.5 | 0.5 | 0.5 | 0.5 | 0.5 |
| | “Sraoff 72N” (remark 5) | | 0.1 | 0.1 | 0.1 | 0.1 | 0.1 |
| | “Nopcosant K” (remark 6) | | 0.5 | 0.6 | 0.5 | 0.5 | 0.5 |
| | “Adekanol UH-438” (remark 7) | | 0.2 | 0.2 | 0.2 | 0.2 | 0.2 |
| | “JR-605” (remark 8) | | 20.0 | 19.2 | 20 | 20 | 20 |
| | “LF Bosei P-W-2” (remark 9) | | | 5.5 | | | |
| | “Sunlight SL-800” (remark 10) | | | | | | |
| | “SN Defoamer 380” (remark 11) | | 0.2 | 0.2 | 0.2 | 0.2 | 0.2 |
| B | Water-based fatty | (I-1) | 69.5 | | | | |
| | acid-modified acryl resin | (I-2) | | 62.4 | | | |
| | | (I-3) | | | 69.5 | | |
| | | (I-4) | | | | 69.5 | |
| | | (I-5) | | | | | 69.5 |
| | | (I-6) | | | | | |
| | | (I-7) | | | | | |
| | | (I-8) | | | | | |

| | | | | | | |
|---|---|---|---|---|---|---|
| | Adipic acid dihydrazide | 0.25 | 0.35 | 0.25 | 0.25 | 0.35 |
| | Texanol | 4.2 | 3.7 | 4.2 | 4.2 | 4.2 |
| | “SN Defoamer 380” (remark 11) | 0.5 | 0.5 | 0.5 | 0.5 | 0.5 |
| | “Adekanol UH-438” (remark 7) | 0.7 | 0.6 | 0.7 | 0.7 | 0.5 |
| | Sodium nitrite | 0.2 | 0.2 | 0.2 | 0.2 | 0.5 |
| | “DICNATE 3111” (remark 12) | 0.8 | 0.7 | 0.8 | 0.8 | 0.5 |
| Property | Titanium white PVC | 15 | 15 | 15 | 15 | 15 |
| value | Phosphoric acid base pigment PVC | 0 | 5 | 0 | 0 | 0 |
| | Extender pigment PVC | 0 | 0 | 0 | 0 | 0 |
| | Whole pigment PVC | 15 | 20 | 15 | 15 | 15 |
| | Oil length | 19.9 | 29.9 | 20 | 20 | 19.9 |
| | Weight average molecular weight | 80,000 | 80,000 | 110,000 | 150,000 | 100,000 |
| | Water vapor permeability | 200 | 220 | 200 | 330 | 280 |

| | | | Production Example | | | | |
|---|---|---|---|---|---|---|---|
| | | | 17 | 18 | 19 | 20 | 21 |
| A | Clean water | | 10.0 | 17.0 | 10.0 | 10.0 | 26.0 |
| | Ethylene glycol | | 0.5 | 0.5 | 0.5 | 0.5 | 0.5 |
| | “Sraoff 72N” (remark 5) | | 0.1 | 0.1 | 0.1 | 0.1 | 0.1 |
| | “Nopcosant K” (remark 6) | | 0.5 | 0.9 | 0.5 | 0.5 | 1.3 |
| | “Adekanol UH-438” (remark 7) | | 0.2 | 0.2 | 0.2 | 0.2 | 0.2 |
| | “JR-605” (remark 8) | | 20 | 18.9 | 20 | 20 | 19.1 |
| | “LF Bosei P-W-2” (remark 9) | | | | | | |
| | “Sunlight SL-800” (remark 10) | | | 16.6 | | | 33.6 |
| | “SN Defoamer 380” (remark 11) | | 0.2 | 0.2 | 0.2 | 0.2 | 0.2 |
| B | Water-based fatty | (I-1) | | | | | |
| | acid-modified acryl resin | (I-2) | | | | | |
| | | (I-3) | | 50.0 | | | 35 |
| | | (I-4) | | | | | |
| | | (I-5) | | | | | |
| | | (I-6) | 63.2 | | | | |
| | | (I-7) | | | 69.5 | | |
| | | (I-8) | | | | 69.5 | |

| | | | | | | |
|---|---|---|---|---|---|---|
| | Adipic acid dihydrazide | 0.25 | 0.25 | 0.25 | 0.25 | 0.25 |
| | Texanol | 4.2 | 3.0 | 4.2 | 4.2 | 2.1 |
| | “SN Defoamer 380” (remark 11) | 0.5 | 0.5 | 0.5 | 0.5 | 0.5 |
| | “Adekanol UH-438” (remark 7) | 0.6 | 0.4 | 0.7 | 0.7 | 0.4 |
| | Sodium nitrite | 0.2 | 0.2 | 0.2 | 0.2 | 0.2 |
| | “DICNATE 3111” (remark 12) | 0.8 | 0.6 | 0.8 | 0.8 | 0.4 |
| Property | Titanium white PVC | 15 | 15 | 15 | 15 | 15 |
| value | Phosphoric acid base pigment PVC | 0 | 0 | 0 | 5 | 0 |
| | Extender pigment PVC | 0 | 20 | 0 | 5 | 40 |
| | Whole pigment PVC | 15 | 35 | 15 | 15 | 55 |
| | Oil length | 24.6 | 20 | 0 | 19.9 | 20 |
| | Weight average molecular weight | 80,000 | 110,000 | 80,000 | 80,000 | 110,000 |
| | Water vapor permeability | 220 | 280 | 420 | 450 | 410 |

(Remark 5) “Sraoff 72N”: trade name, manufactured by Takeda Yakuhin Co., Ltd., antiseptic agent

(Remark 6) “Nopcosant K”: trade name, manufactured by Sun Nopco Co., Ltd., pigment dispersant

(Remark 7) “Adekanol UH-438”: trade name, manufactured by Adeka Co., Ltd., thickener

(Remark 8) “Titanium White JR-605”: trade name, manufactured by Tayca Corporation, titanium white, specific gravity: 4.1

(Remark 9) “LF Bosei P—W-2”: trade name, manufactured by Kikuchi Color Co., Ltd., zinc phosphate base rust preventive pigment, specific gravity: 3.5

(Remark 10) “Sunlight SL-800”: trade name, manufactured by Takehara Chemical Co., Ltd., calcium carbonate, specific gravity: 2.7

(Remark 11) “SN Defoamer 380”: trade name, manufactured by Sun Nopco Co., Ltd., defoaming agent

(Remark 12) “DICNATE 3111”: trade name, manufactured by Dainippon Ink & Chemicals Inc., metal dryer

Water vapor permeability: measured according to a method described in JIS Z 0208

Production of Water-Based Under Coating Material

### Production Examples 22 to 24

A vessel was charged in order with the respective components shown in Composition (C) of Table 3, and the mixture was continued to be stirred for 30 minutes by means of a disper until it became homogeneous to obtain

pigment pastes. Then, the respective components shown in Composition (C) of Table 3 were added in order to the above pigment pastes to produce the respective water-based under coating materials A to C.

TABLE 3

| | | Production | | |
|---|---|---|---|---|
| | | Example | | |
| | | 22 | 23 | 24 |
| Water-based under coating material | | A | B | C |
| Composition C | Clean water | 16 | 14 | 16 |
| | Ethylene glycol | 0.5 | 0.5 | 0.5 |
| | “Sraoff 72N” (remark 5) | 0.1 | 0.1 | 0.1 |
| | “Nopcosant K” (remark 6) | 0.8 | 0.7 | 0.8 |
| | “Adekanol UH-438” (remark 7) | 0.2 | 0.2 | 0.2 |
| | “Red Iron Oxide N-58” | 5.8 | 5.9 | 5.8 |
| | (remark 13) | | | |
| | “LF Bosei P-W-2” (remark 9) | | 8.1 | |
| | “K-WHITE 140W” (remark 14) | 6.8 | | 6.8 |
| | “Sunlight SL-800” (remark 10) | 18.4 | 12.5 | 18.4 |
| Composition D | “50% Uradil AZ-516” (remark 15) | 25.1 | 30 | |
| | “38% Resydrol AY-586w/38WA” | | | 33 |
| | (remark 16) | | | |
| | “SN Defoamer 380” (remark 11) | 0.5 | 0.5 | 0.5 |
| | “Adekanol UH-438” (remark 7) | 0.5 | 0.5 | 0.5 |
| | Sodium nitrite | 0.2 | 0.2 | 0.2 |
| | “DICNATE 3111” (remark 12) | 0.4 | 0.5 | 0.4 |
| Pigment | Red iron oxide PVC | 5 | 5 | 5 |
| concentration | Phosphoric acid base pigment PVC | 10 | 10 | 10 |
| | Extender pigment PVC | 30 | 20 | 30 |
| | Whole pigment PVC | 45 | 35 | 45 |

(Remark 13) “Red Iron Oxide N-58”: trade name, manufactured by Nihon Bengara Co., Ltd., red iron oxide, specific gravity: 5.1

(Remark 14) “K-WHITE 140W”: trade name, manufactured by Tayca Corporation, aluminum tripolydihydrogenphosphate, specific gravity: 3.0

(Remark 15) “50% Uradil AZ-516”: trade name, manufactured by DSM Resin Co., Ltd., solid matter content 50% water-based alkyd resin, solid matter content: 50%

(Remark 16) “38% Resydol AY-586w/38WA”: trade name, manufactured by Solutia Co., Ltd., acryl-modified long oil water-based alkyd resin, solid matter content: 38%

Preparation of Test Coated Plate

### Examples 1 to 9 and Comparative Examples 1 to 4

A steel plate (150×70×0.8 mm) prescribed in JIS K 5410 which was defatted with xylene was used as a substrate. Each water-based under coating material shown in the following Table 4 was coated on the above substrate in a coating amount of 100 g/m² and dried on the conditions of an air temperature of 20° C. and a relative humidity of 60% for a day to provide an under coating film having a dried film thickness of 30 nm. Then, each water-base coating material shown in Table 4 which was diluted to about 70 KU with clean water was coated thereon by a brush so that a coating amount was 100 g/m², and each water-based coating material was further coated thereon after 4 hours so that a coating amount was 100 g/m². Then, it was dried on the conditions of an air temperature of 20° C. and a relative humidity of 60% for 7 days to form an upper coating film having a dried film thickness of 60 nm by the coating material, whereby each test coated plate was prepared. The respective test coated plates thus obtained were subjected to the following tests. The results thereof are shown in Table 4.

TABLE 4

| | Example | | | | | | | | |
|---|---|---|---|---|---|---|---|---|---|
| | 1 | 2 | 3 | 4 | 5 | 6 | 7 | 8 | 9 |
| Water-based | A | A | A | A | A | A | A | B | C |
| under coating | | | | | | | | | |
| material | | | | | | | | | |
| Water-based | Production | Production | Production | Production | Production | Production | Production | Production | Production |
| coating | Example | Example | Example | Example | Example | Example | Example | Example | Example |
| material | 12 | 13 | 14 | 15 | 16 | 17 | 18 | 12 | 12 |
| Build feeling | ◯ | ⊚ | ◯ | ◯ | ◯ | ◯ | ◯ | ◯ | ◯ |
| Glossiness | 84 | 81 | 83 | 80 | 83 | 83 | 41 | 84 | 84 |
| Corrosion | ◯ | ◯ | ◯ | ◯Δ | ◯Δ | ◯ | ◯Δ | ◯ | ◯ |
| resistance | | | | | | | | | |
| Accelerated | 8 points | 8 points | 8 points | 10 points | 8 points | 8 points | 8 points | 8 points | 8 points |
| weatherability | | | | | | | | | |

| | Comparative Example | | | |
|---|---|---|---|---|
| | 1 | 2 | 3 | 4 |
| Water-based under | A | A | A | No under |
| coating material | | | | coating |
| Water-based coating | Production | Production | Production | Production |
| material | Example 19 | Example 20 | Example 21 | Example 12 |
| Build feeling | X | ◯ | X | ◯ |
| Glossiness | 78 | 47 | 5 | 84 |
| Corrosion resistance | Δ | Δ | X | Δ |
| Accelerated | 8 points | 8 points | 6 points | 8 points |
| weatherability | | | | |
| (*1) Build feeling: each water-based coating material was coated, and then the coating film appearance was visually evaluated one day later after dried: ⊚: particularly excellent in build feeling ◯: excellent in build feeling X: poor in build feeling | | | | |
| (*2) Glossiness (60 degree gloss): the test coated plates were measured according to a test method of a relative-specular glossiness prescribed in JIS K 5600 4-7 | | | | |
| (*3) Corrosion resistance: the water-based coating material was coated and then dried on the conditions of an air temperature of 20° C. and a relative humidity of 60% for 7 days, and then this was subjected to a combined cycle corrosion resistance test prescribed in JIS K 5621 in 36 cycles to evaluate the surface of the coating film according to the following criteria: | | | | |
| #◯: no rusts are observed on the coating film ◯Δ: rusts are observed on a very small part of the coating film Δ: rusts are observed on a part of the coating film X: rusts are observed on the whole face of the coating film | | | | |

(*4) Accelerated weatherability: the respective test coated plates were irradiated for 1000 hours according to an accelerated weatherability test prescribed in 9.8.1 (sunshine carbon arc lamp method) of JIS K 5400, and then the respective coated faces were evaluated accord

What is claimed is:

1. A coating finishing method comprising coating a water-based under coating material (I) on a surface of a metal substrate or an old coated face of a metal substrate and then coating on a coated surface thereof, a water-based coating material (II) comprising a water-based fatty acid-modified acryl resin as a base resin component, wherein the above water-based coating material (II) contains a pigment in a pigment volume concentration falling in a range of 5 to 45%, and the above water-based fatty acid-modified acryl resin has a form of a fine particle having an average particle diameter falling in a range of 50 to 500 nm.

2. The method as described in claim 1, wherein the water-based under coating material (I) contains a phosphoric acid base pigment.

3. The method as described in claim 1 or 2, wherein the water-based fatty acid-modified acryl resin is a resin comprising a structural unit derived from a fatty acid (a), an epoxy group-containing polymerizable unsaturated monomer (b), an acid group-containing polymerizable unsaturated monomer (c), a polymerizable unsaturated monomer (d) having an alkyl group having 4 or more carbon atoms and the other polymerizable unsaturated monomer (e).

4. The method as described in claim 3, wherein the polymerizable unsaturated monomer (d) having an alkyl group having 4 or more carbon atoms contains a polymerizable unsaturated monomer having a linear or branched hydrocarbon group having 6 or more carbon atoms.

5. The method as described in claim 3 or 4, wherein the polymerizable unsaturated monomer (d) having an alkyl group having 4 or more carbon atoms contains a polymerizable unsaturated monomer having a cycloalkyl group.

6. The method as described in any of claims 3 to 5, wherein the other polymerizable unsaturated monomer (e) contains a carbonyl group-containing polymerizable unsaturated monomer and/or a vinyl aromatic compound.

7. The method as described in any of claims 1 to 6, wherein the water-based coating material (II) further contains a hydrazine derivative.

8. The method as described in any of claims 1 to 7, wherein the water-based coating material (II) further contains at least one compound selected from the group consisting of nitrites, phytates, tannates, phosphates and polyamine compounds.

9. The method as described in any of claims 1 to 8, wherein the water-based coating material (II) forms a coating film having a water vapor permeability of 400 g/m²·24 hr or less.

10. A coated article which is coated and finished by the method as described in any of claims 1 to 7.
